(19) United States
(12) Patent Application Publication
(10) Pub. No.: US 2025/0291585 A1
(43) Pub. Date: Sep. 18, 2025

(54) SYSTEM AND METHOD FOR DYNAMICALLY CONFIGURING AND AUTONOMOUSLY MANAGING SOFTWARE PRODUCT SOLUTIONS

(71) Applicant: Guaranteed Rate, Inc., Chicago, IL (US)

(72) Inventors: Ramesh SARUKKAI, Los Gatos, CA (US); Mayur SHAH, Plano, TX (US); Sadique Ali KOOTHUMADAN, Livermore, CA (US)

(21) Appl. No.: 19/081,011

(22) Filed: Mar. 17, 2025

Related U.S. Application Data
(60) Provisional application No. 63/565,995, filed on Mar. 15, 2024.

(51) Int. Cl. G06F 8/71

(52) U.S. Cl. CPC G06F 8/71

(57) ABSTRACT

Disclosed method and system include a server that configures integration between multiple application processes and multiple modular applications based on multiple configuration files and a request to initiate one of the application processes. The server retrieves a configuration file associated with the application process and state information of the application process from a database. The configuration file includes states, transitions, and events. The server receives user information for the application process from a user device and determines the next step of the application process based on the state information, the user information, the set of states, the set of transitions, and the set of events. Upon determination of the next step, the server executes a request to at least one modular application integrated with the application process. The server repeats the determination and execution steps until the state information indicates completion of the application process.

### CROSS-REFERENCE TO RELATED APPLICATIONS/INCORPORATION BY REFERENCE

This Patent Application makes reference to, claims priority to, and claims the benefit of U.S. provisional application 63/565,995 filed Mar. 15, 2024, the contents of which is hereby incorporated herein by reference in its entirety.

### FIELD

Various embodiments of the disclosure relate generally to a modular software system. More specifically, various embodiments of the disclosure relate to a system and a method for dynamically configuring and autonomously managing software product solutions.

### BACKGROUND

Traditional software development processes necessitate building new product development suites from scratch, leading to inefficiencies, resulting in prolonged development cycles, limited reusability of components, and rigid product and service development. Moreover, manual intervention is required for updating, scaling, and maintaining software solutions, which may be time-consuming and prone to errors. Further, the likelihood of failing to meet evolving customer requirements increases, ultimately affecting the overall success and sustainability of software products.

In light of the foregoing, there exists a need for a technical and reliable solution that overcomes the above-mentioned problems, challenges, and shortcomings of conventional software development processes.

Limitations and disadvantages of conventional and traditional approaches will become apparent to one of skill in the art, through the comparison of described systems with some aspects of the present disclosure, as set forth in the remainder of the present disclosure and with reference to the drawings.

### SUMMARY

Methods and systems for dynamically configuring and autonomously managing software product solutions are provided substantially as shown in, and described in connection with, at least one of the figures.

In one embodiment of the present disclosure, a method for dynamically configuring and autonomously managing software product solutions is disclosed. The method includes configuring, by a server, integration between a plurality of application processes and a plurality of modular applications based on a plurality of configuration files associated with the plurality of application processes. Each application process of the plurality of application processes is associated with one or more modular applications of the plurality of modular applications. The method further includes receiving, by the server from a user device, a request to initiate a first application process of the plurality of application processes and retrieving, by the server from a database, a first configuration file of the plurality of configuration files associated with the first application process and first state information indicating a current status of the first application process to initiate the first application process. The first configuration file includes a first set of states, a first set of transitions, and a first set of events. The method further includes receiving, by the server from the user device, first user information for the first application process and determining, by the server, a next step of the first application process based on the first state information, the first user information, the first set of states, the first set of transitions, and the first set of events. The method further includes executing, by the server based on the determined next step, a request to at least one modular application of a plurality of modular applications integrated with the first application process and repeating, by the server, the determining of the next step and the executing of the request to at least one modular application of the plurality of modular applications integrated with the first application process, until the first state information indicates completion of the first application process.

In some embodiments, the method further includes generating, by the server, the plurality of configuration files. Each configuration file comprises a set of states, a set of transitions, and a set of events associated with a corresponding application process of the plurality of application processes. Each configuration file of the plurality of configuration files corresponds to at least one of a file generated utilizing a low code tool, a JavaScript Object Notation (JSON) file, or a file generated utilizing user inputs.

In some embodiments, each state of the first set of states corresponds to a status of the first application process. Each transition of the first set of transitions corresponds to a change in the status of the first application process from one state of the first set of states to another state of the first set of states. Each event of the first set of events corresponds to an action that triggers the transition of the first application process from one state of the first set of states to another state of the first set of states.

In some embodiments, when the modular application corresponds to an internal platform service application, the executing of the request to the at least one modular application comprises transmitting, by the server to a platform service provider, an application programming interface (API) call to process the request and receiving, by the server from the platform service provider, a response associated with the processing of the request. The response comprises a set of event notifications. The next step is determined based on the set of event notifications.

In some embodiments, when the modular application corresponds to an external service application, the executing of the request to the at least one modular application comprises transmitting, by the server to an external service provider, an API call to process the request and receiving, by the server from the external service provider, a response associated with the processing of the request. The response comprises a set of event notifications. The next step is determined based on the set of event notifications.

In some embodiments, the method further includes transmitting, by the server to one of a manual review provider or an artificial intelligence (AI) engine, an API call to process the request and receiving, by the server from one of the manual review provider and the AI engine, a response associated with the processing of the request. The response comprises a set of event notifications. The next step is determined based on the set of event notifications.

In some embodiments, the method further includes storing, by the server, the first state information in the database.

In some embodiments, the method further includes rendering, by the server, a user interface on the user device to present the next step based on the first state information, the first user information, the first set of states, the first set of transitions, and the first set of events and repeating, by the server, the rendering of the user interface to present the next step until the first state information indicates completion of the first application process.

In some embodiments, the method further includes receiving, by the server from the user device, a request to initiate a second application process of the plurality of application processes and retrieving, by the server from the database, a second configuration file of the plurality of configuration files associated with the second application process and second state information indicating a current status of the second application process to initiate the second application process. The second configuration file includes a second set of states, a second set of transitions, and a second set of events. The method further includes receiving, by the server from the user device, second user information for the second application process and determining, by the server, a next step of the second application process based on the second state information, the second user information, the second set of states, the second set of transitions, and the second set of events. The method further includes executing, by the server based on the determined next step, a request to at least one modular application of the plurality of modular applications integrated with the second application process and repeating, by the server, the determining of the next step and the executing of the request to the at least one modular application integrated with the second application process, until the second state information indicates completion of the second application process.

In some embodiments, the server integrates (i) the first application process with at least one of a first modular application and a second modular application, of the plurality of modular applications and (ii) the second application process with at least one of the second modular application and a third modular application of the plurality of modular applications.

In one embodiment of the present disclosure, a system for dynamically configuring and autonomously managing software product solutions is disclosed. The system includes a server configured to configure integration between a plurality of application processes and a plurality of modular applications based on a plurality of configuration files associated with the plurality of application processes. Each application process of the plurality of application processes is associated with one or more modular applications of the plurality of modular applications. The server is further configured to receive, from a user device via a communication network, a request to initiate a first application process of the plurality of application processes and retrieve, from a database, a first configuration file of the plurality of configuration files associated with the first application process and first state information indicating a current status of the first application process to initiate the first application process. The first configuration file includes a first set of states, a first set of transitions, and a first set of events. The server is further configured to receive, from the user device, first user information for the first application process and determine a next step of the first application process based on the first state information, the first user information, the first set of states, the first set of transitions, and the first set of events. The server is further configured to execute, based on the determined next step, a request to at least one modular application of a plurality of modular applications integrated with the second application process and repeat the determination of the next step and the execution of the request to the at least one modular application integrated with the first application process, until the first state information indicates completion of the first application process.

The disclosed methods and systems may facilitate the orchestrator server that is fully configurable. The orchestrator server supports creating custom user journeys by mapping user journeys to a set of backend actions/states and conditions, integrating actions for each user interaction (function calls, service APIs, manual human integration, AI engine interactions). The aforementioned solution thus has significant benefits over traditional software development processes, such as, but not limited to, rapid innovation across new businesses and product types, efficient reuse of technology systems and development resources, maximum reusability of sub-systems and services, high confidence quality checking as well as reusability of test harnesses, ability to react to changes in business needs and requirements, no-code solutions to new products via configurable products, orchestrated custom user journeys based on product and business needs, and efficient combination of automated digital tasks and custom manual tasks all seamlessly plugged into a unified user journey.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

The following detailed description of the preferred embodiments of the present disclosure will be better understood when read in conjunction with the appended drawings. The present disclosure is illustrated by way of example, and not limited by the accompanying figures, in which like references indicate similar elements.

FIG. 1 is a block diagram that illustrates an environment for dynamically configuring and autonomously managing software product solutions, in accordance with an embodiment of the disclosure;

FIG. 2 is a process flow diagram that illustrates configuration and execution of an application process, in accordance with an embodiment of the present disclosure;

FIG. 3 is a block diagram that illustrates an orchestrator server of the environment of FIG. 1, in accordance with an embodiment of the disclosure;

FIG. 4 is a diagram that illustrates a configuration file associated with an application process, in accordance with an embodiment of the disclosure;

FIG. 5 is a block diagram that illustrates a customized environment for a home equity line of credit (HELOC) application process, in accordance with an embodiment of the disclosure;

FIG. 6 is a table illustrating integration of services along with various application processes to be executed by the orchestrator server, in accordance with an embodiment of the disclosure;

FIGS. 7A and 7B, collectively, represent a flowchart illustrating a method for dynamic configuration and autonomous managing of software product solutions, in accordance with an embodiment of the disclosure; and

FIG. 8 is a block diagram that illustrates a system architecture of a computer system for dynamic configuration and autonomous managing of software product solutions, in accordance with an exemplary embodiment of the disclosure.

### DETAILED DESCRIPTION

Traditional software development processes require building new product suites from scratch, leading to inefficiencies, prolonged development cycles, limited reusability, and rigid product development. Consequently, enterprises face challenges in adapting to changing market demands and integrating new functionalities, ultimately impacting their competitiveness. Additionally, manual updates and maintenance increase the risk of failing to meet evolving customer requirements, affecting the sustainability of software products. In the financial domain, these challenges are further magnified by the need for sophisticated lending systems that offer fast digital experiences, optimized processes, seamless third-party integration, real-time notifications, instantaneous decision-making, and robust fraud prevention mechanisms. The conventional approach to developing new financial products or services hampers efficiency and accuracy, resulting in prolonged development times and failing to meet the specific requirements.

The specification and accompanying drawings disclose one or more exemplary embodiments that incorporate the features of the present disclosure. The scope of the present disclosure is not limited to the disclosed embodiments. The disclosed embodiments merely exemplify the present disclosure, and modified versions of the disclosed embodiments are also encompassed by the present disclosure. Embodiments of the present disclosure are defined by the claims appended hereto.

It is noted that any section/subsection headings provided herein are not intended to be limiting. Any embodiments described throughout this specification, and disclosed in any section/subsection may be combined with any other embodiments described in the same section/subsection and/or a different section/subsection in any manner.

Software product solutions refer to comprehensive software applications or systems designed to address specific business or consumer needs. The software product solutions encompass a wide range of functionalities and features tailored to solve particular problems, automate processes, enhance productivity, or provide new capabilities. Important aspects of the software product solutions include customization, allowing them to meet the unique requirements of different users, industries, or sectors. The software product solutions are designed to scale with the growth of an organization, accommodating increased workloads and user demands. Integration with other systems, platforms, or third-party services is an important feature, providing a seamless user experience and enhancing overall functionality. The software product solutions may range from simple applications to complex systems, including enterprise resource planning (ERP) software, customer relationship management (CRM) systems, financial management tools, and more. They are essential for businesses and consumers to streamline operations, improve decision-making, and achieve their goals effectively.

In the financial domain, traditional software development processes to create software product solutions encounter several technical challenges that may hinder efficiency and accuracy. One significant problem is the requirement to build new product suites from scratch for each project to customize the product suites as per the requirements. This approach leads to inefficiencies, as developers must repeatedly create and configure components that could otherwise be reused. Consequently, this lack of reusability results in prolonged development cycles, as each project starts from scratch. Additionally, traditional software development processes suffer from rigidity in product and service development, making it difficult to adapt to changing market demands or incorporate new functionalities seamlessly.

Manual intervention is another technical challenge associated with traditional software development processes. Updating, scaling, and maintaining software solutions typically require significant manual effort, which may be time-consuming and prone to errors, increasing the likelihood of failing to meet evolving customer requirements, ultimately affecting the overall success and sustainability of the software product solutions. Furthermore, the traditional approach lacks efficient integration with third-party services and systems due to involvement of complex and time-consuming integration processes.

In accordance with the disclosed embodiments, a method and a system for dynamically configuring and autonomously managing software product solutions utilizing an orchestrator server is provided. The orchestrator server configures integration between multiple application processes and multiple modular applications based on multiple configuration files associated with the application processes. Each application process is associated with one or more modular applications. When a user requests to initiate a first application process via a user device, the orchestrator server retrieves a first configuration file associated with the first application process and state information indicating a current status of the first application process from a database server and receives user information for the first application process from the user device. The first configuration file includes a first set of states, a first set of transitions, and a first set of events. Based on the state information, the user information, the first set of states, the first set of transitions, and the first set of events, the orchestrator server determines a next step in the application process and executes a request to at least one integrated modular application. The aforementioned process of determining a next step in the application process and executing the request to the at least one integrated modular application is repeated until the first application process is complete.

The aforementioned method and system significantly streamline the development and management of software solutions by automating the configuration and execution of application processes. The system corresponds to a modular software system that modifies backend processing to provide improved front-end experiences. The orchestrator server ensures that processes are carried out efficiently and accurately based on predefined configurations, reducing the need for manual intervention. By automating the configuration and execution of application processes, the method reduces development time and manual effort, and the use of configuration files allows for efficient customization and modification of application processes to meet evolving requirements. Any new application processes may be created by generating a corresponding configuration file, thus making it scalable to add new software product solutions on the go. Thus, the system may adjust to the highly sophisticated and multi-dimensional needs of businesses and consumers by providing fast digital experiences that stand independent or embedded while spanning multi-form factors. The experiences are operationally optimized to support processes that are orchestrated and tailored based on individual consumer and tenant (business) needs. Additionally, in the present disclosure, one or more modular integrated applications may be commonly utilized for one or more application processes, thereby facilitating improved resource utilization and reducing overhead.

Further, human errors are minimized due to automation and the orchestrator server ensures consistent execution of application processes due to the ability to just in time integrate with modular applications which allow for seamless incorporation of third-party services and functionalities. The system receives real-time notifications from the modular applications, such as the third party services resulting in super-fast consumer turnaround. The orchestrator server may retrieve diverse and large set of attributes (static and dynamic) and process them quickly for underwriting and decisioning purposes. Additionally, the orchestrator server may be adapted to make real-time decisions based on current state information, ensuring that the application processes are dynamically managed and adapted to changing conditions. The system further facilitates robust fraud prevention controls and identity verification techniques to combat high risk and fraudulent behavior.

The system disclosed herein provides a common platform that allows for autonomous and dynamic solutions across a range of diverse products and services, for diverse segments of customers/users, with flexibility in requirements, vendor integrations, revenue and investor models, combined with classical systems such as fraud detection and/or identity solutions. The orchestrator server is configuration-driven (i.e., low code, a software development approach that requires little to no coding to build applications and processes) and may quickly compose together custom experiences (e.g., aspects of the system the user will experience for a selected service/product) combined with backend processes, actions, services, and notifications for the selected service/product, resulting in rapid creation and deployment of custom user journeys for various digital products. The orchestrator server is not limited to just building experiences but may be used to build, compose, and orchestrate any digital application that has custom user journeys, set of actions/states and transitions with conditions and backend processes (manual or automated) that are integrated synchronously or asynchronous with events. In other words, the platform disclosed herein is autonomous, flexible, resilient, composable, and adaptive to changing business and consumer requirements. The approach is applicable to an extended variety of use cases, indeed, any solution that requires gathering information from customers, the data being processed via a business or application process, with a well-defined outcome (such as a decision or an approval or completion of a successful application process) may be built with this system.

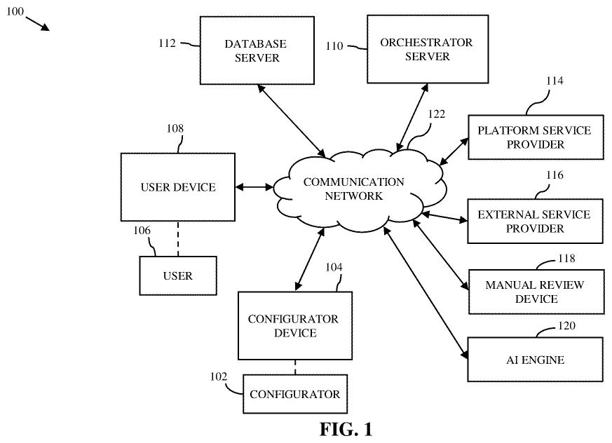

Having given this description of the method for dynamically configuring and autonomously managing software product solutions utilizing an orchestrator server that may be applied within the context of the present disclosure, technologies will now be described for the system for dynamically configuring and autonomously managing software product solutions with reference to FIGS. 1-8.

FIG. 1 is a block diagram that illustrates an environment 100 for dynamically configuring and autonomously managing software product solutions, in accordance with an embodiment of the disclosure. The environment 100 may include a configurator 102, a configurator device 104, a user 106, a user device 108, an orchestrator server 110, a database server 112, a platform service provider 114, an external service provider 116, a manual review provider 118, and an artificial intelligence (AI) engine 120. The configurator device 104, the user device 108, the orchestrator server 110, the database server 112, the platform service provider 114, the external service provider 116, the manual review provider 118, and the AI engine 120 may be communicatively coupled to each other via a communication network 122.

The configurator 102 may be an individual, such as a software developer or a business entity, who may want to build an application process. The application process may correspond to a software application or system designed to address specific business or consumer needs. The application process may be integrated with other systems, platforms, or third-party services to provide a seamless user experience and enhance overall functionality. The application process may range from simple applications to complex systems, including enterprise resource planning (ERP) software, customer relationship management (CRM) systems, financial management tools, and the like. In one example, the application process may correspond to a financial management tool, such as, a home loan application, a home equity line of credit (HELOC) application, a mortgage application, a reverse mortgage application, a home search application, a personal loan application, an insurance application, a pay later (PL) application, a book now pay later (BNPL) application, an auto loan application, a solar loan application, and the like. The application process may be built, by the configurator 102, by utilizing a configurator device 104.

The configurator device 104 may include suitable logic, circuitry, interfaces, and/or code, executable by the circuitry, that may be configured to perform one or more operations. For example, the configurator device 104 may be a computing device that is utilized, by the configurator 102, to initiate the one or more operations by means of a service application (associated with the dynamic configuration service provider and hosted by the orchestrator server 110) running on the configurator device 104. For example, the configurator device 104 may facilitate generation of a configuration file associated with an application process. A set of inputs may be provided, by the configurator 102, by utilizing the service application running on the configurator device 104 to initiate generation of the configuration file. The configuration file may be associated with a list of services required for the application process. The configuration file may include information, for example, a description of the application process, a type of application process, or the like.

The set of inputs may be provided by the configurator 102, by way of a touch-based input, a text-based input, a voice-based input, a gesture-based input, or a combination thereof. Further, the configurator device 104 may be configured to transmit the set of inputs received from the configurator 102 to the orchestrator server 110 via the communication network 122. In some embodiments, the service application (running on the configurator device 104) may be configured to transmit the set of inputs provided by the configurator 102 to the orchestrator server 110 via the communication network 122. The set of inputs may include, but is not limited to, an algorithm, a software code, and the like. In some more embodiments, the list of services may include internal platform services provided by the platform service provider 114, third party services provided by the external service provider 116, and verification services provided by the manual review provider 118 and the AI engine 120.

In an embodiment, the configurator device 104 may be configured to receive, from the orchestrator server 110, one or more user interfaces that allow the configurator 102 to interact with one or more computing devices, servers, or applications for performing the one or more operations. The one or more user interfaces may be received in response to the provisioning of the set of inputs by the configurator 102. Further, the configurator device 104 may be utilized, by the configurator 102, to view the one or more user interfaces (one at a time) rendered by the orchestrator server 110. The configurator 102 may interact with each user interface to provide one or more inputs for initiating the one or more operations associated with the configuration request. For example, the configurator device 104 may be utilized, by the configurator 102, to select multiple blocks of code as an input to generate the configuration file. The configuration file may correspond to a flow definition artifact associated with the application process. Further, the configuration file may correspond to at least one of a file generated utilizing a low code tool, a JavaScript Object Notation (JSON) file, or a customized file. In one example, the low code tool may correspond to a what you see is what you get (WYSIWYG) low code tool. Further, the customized file may correspond to a file generated in a domain-specific language artifact. Examples of the configurator device 104 include, but are not limited to, a personal computer, a laptop, a smartphone, a smart wearable device, and a tablet computer.

The user 106 may be an individual who may want to avail at least one application process of a plurality of application processes offered by the orchestrator server 110. The at least one application process may be availed, by the user 106, by initiating a request to initiate the at least one application process. The request may be initiated, by the user 106, by utilizing the user device 108. In one example, the user 106 may want to avail a financial tool for the home loan application, the HELOC application, the mortgage application, the reverse mortgage application, the home search application, the personal loan application, the insurance application, the pay later application, the book now pay later application, the auto loan application, the solar loan application, and the like.

The user device 108 may include suitable logic, circuitry, interfaces, and/or code, executable by the circuitry, that may be configured to perform one or more operations. For example, the user device 108 may be a computing device that is utilized, by the user 106, to initiate the one or more operations by means of a service application (associated with the autonomous software solution provider and hosted by the orchestrator server 110) running on the user device 108. For example, the user device 108 may be utilized, by the user 106, to generate the request to initiate the first application process. Examples of the service application may include, but are not limited to, a website, a mobile site, and a conversational chat application. To generate the request, an input is provided, by the user 106, by utilizing the service application running on the user device 108, indicating selection of a first application process from the plurality of application processes. The request to initiate the first application process may correspond to one of a hypertext transfer protocol (HTTP) request and a representational state transfer (REST) request. The user 106 may further utilize the user device 108 to input first user information for the first application process. In some embodiments, the first user information may include at least one of a name, identification details of the user 106, and application-specific details. In one example, when the user 106 wants to avail an auto loan, the user 106 may provide vehicle details and financial details along with the name and the identification details. Various modes of input that may be utilized by the user 106 to generate the request include, but are not limited to, a touch-based input, a text-based input, a voice-based input, a gesture-based input, or a combination thereof. Further, the user device 108 may be configured to transmit the request to initiate the first application process to the orchestrator server 110 via the communication network 122. In some more embodiments, the service application (running on the user device 108) may be configured to transmit the request to the orchestrator server 110 via the communication network 122.

In an embodiment, the user device 108 may be configured to receive, from the orchestrator server 110, one or more user interfaces that allow the user 106 to interact with one or more computing devices, servers, or applications for performing the one or more operations for the first application process. The one or more user interfaces may be received in response to the request transmitted by the user device 108 to initiate the first application process. Further, the user device 108 may be utilized, by the user 106, to view the one or more user interfaces (one at a time) rendered by the orchestrator server 110. The user 106 may interact with each user interface to provide one or more inputs for initiating the one or more operations associated with the request to initiate the first application process. For example, the user device 108 may be utilized, by the user 106, to provide the first user information for the first application process.

In an embodiment, the user device 108 may be configured to receive allocation information from the orchestrator server 110 based on allocation of respective service, such as the auto loan, to the user 106. The user device 108 may be further utilized, by the user 106, to view the allocation information. Examples of the user device 108 include, but are not limited to, a personal computer, a laptop, a smartphone, a smart wearable device, and a tablet computer.

Although it is described that the user 106 is operating the user device 108 to avail the plurality of application processes, the scope of the present disclosure is not limited to it. In additional embodiments, the environment 100 may include a plurality of users operating a plurality of user devices, respectively, to avail one or more application processes of the plurality of application processes, without deviating from the scope of the present disclosure. It will further be understood by a person skilled in the art that one or more users of the plurality of users may avail one or more application processes of the plurality of application processes at different time instances or at a same time instance.

The orchestrator server 110 may include suitable logic, circuitry, interfaces, and/or code, executable by the circuitry, that may be configured to perform one or more operations for dynamic configuration and autonomous managing of software product solutions. The orchestrator server 110 may be a computing device, which may include a software framework, that may be configured to create the orchestrator server implementation and perform the various operations associated with the dynamic configuration and autonomous managing of software product solutions. The orchestrator server 110 may be realized through various web-based technologies, such as, but not limited to, a Java web-framework, a .NET framework, a PHP framework, a python framework, or any other web-application framework. Examples of the orchestrator server 110 include, but are not limited to, a personal computer, a laptop, or a network of computer systems.

In some embodiments, the orchestrator server 110 may be configured to process, control, and manage various functionalities and operations such as dynamic configuration of application processes, initiation of application processes, determination of next step in application processes, and execution of steps of application processes. For example, the orchestrator server 110 may be configured to configure integration between the plurality of application processes and a plurality of modular applications based on a plurality of configuration files associated with the plurality of application processes. Each application process of the plurality of application processes may be associated with one or more modular applications of the plurality of modular applications. Each configuration file may comprise a set of states, a set of transitions, and a set of events corresponding to the respective application process of the plurality of application processes. The orchestrator server 110 is further configured to receive, from the user device 108, a request to initiate the first application process of the plurality of application processes.

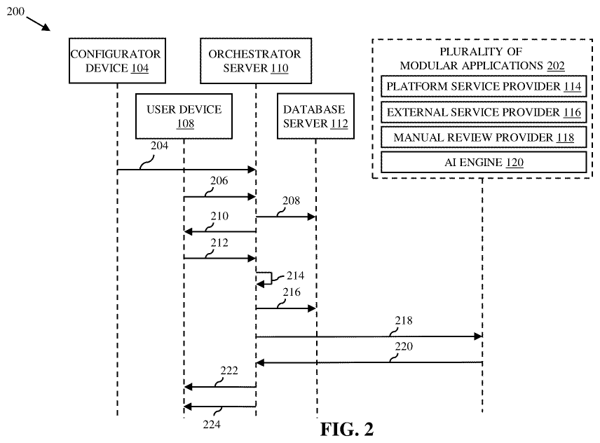

The orchestrator server 110 may be configured to retrieve a first configuration file of the plurality of configuration files associated with the first application process and first state information indicating a current status of the first application process from the database server 112 to initiate the first application process. The first configuration file includes a first set of states, a first set of transitions, and a first set of events. The orchestrator server 110 may be further configured to receive the first user information for the first application process from the user device 108. Based on the first state information, the first user information, a response of a current step of the first application process, the first set of states, the first set of transitions, and the first set of events, the orchestrator server 110 determines the next step of the first application process. Upon determination of the next step, the orchestrator server 110 executes a request to at least one modular application of a plurality of modular applications integrated with the first application process. In one embodiment, the modular application may correspond to at least one of an internal platform service application, an external service application, and a verification application. The orchestrator server 110 is configured to repeat the determining of the next step of the first application process and the executing of the request to at least one modular application based on the determined next step until the first state information indicates completion of the first application process. Various operations and functionalities of the orchestrator server 110 have been described in detail in conjunction with FIGS. 2-8.

The database server 112 may include suitable logic, circuitry, interfaces, and/or code, executable by the circuitry, that may be configured to perform one or more operations, such as receiving, storing, processing, and transmitting queries, data, or content. The database server 112 may be a data management and storage computing device that is communicatively coupled to the configurator device 104, the user device 108, and the orchestrator server 110 via the communication network 122 to perform the one or more operations. In an exemplary embodiment, the database server 112 may be configured to manage and store historical requests to initiate one or more application processes associated with the user 106. The historical requests of the user 106 may include the first user information and data associated with the application processes availed by the user 106 in the past. The database server 112 may be configured to receive the historical requests of the user 106 from the user device 108 or the orchestrator server 110.

The database server 112 may be further configured to manage and store the plurality of configuration files generated by the configurator 102. Each configuration file comprises a set of states, a set of transitions, and a set of events corresponding to the respective application process of the plurality of application processes. In an embodiment, the database server 112 may be configured to generate a data structure including one or more rows and columns for storing the configuration file of each application process in a structured manner. For example, each row may be associated with a unique passenger identifier (ID) of each application process, and one or more columns corresponding to each row may indicate the set of states, the set of transitions, the set of events, and the list of service required for the corresponding application process. In an embodiment, the database server 112 may be configured to store state information (i.e., information indicating the current status) of the application process initiated by the user 106. The state information of the respective application process may be dynamically updated in real-time by the orchestrator server 110 based on the current state, transition, and event associated with the application process. The current state, transition, and event of the application process may indicate whether the application process may transition to the next step or the next state of the application process.

In an embodiment, the database server 112 may be configured to receive a query from the orchestrator server 110 via the communication network 122. The query may correspond to an encrypted message that is decoded by the database server 112 to determine a request for retrieving requisite information (such as the state information, at least one configuration file of the plurality of configuration files, or any combination thereof). In response to the determined request, the database server 112 may be configured to retrieve and communicate the requested information to the orchestrator server 110 via the communication network 122. Examples of the database server 112 may include, but are not limited to, a personal computer, a laptop, or a network of computer systems.

It will be apparent to a person skilled in the art that although in the present embodiment, the database server 112 is shown as a separate entity from the orchestrator server 110, the scope of the present disclosure may not be limited to it. In various other embodiments, the database server 112 may be integrated within the orchestrator server 110, or a memory device of the orchestrator server 110 may act as the database server 112, without deviating from the scope of the present disclosure.

The platform service provider 114 may correspond to a system for providing multiple platform services that are internally integrated with the orchestrator server 110. The platform service provider 114 may include suitable logic, circuitry, interfaces, and/or code, executable by the circuitry, that may be configured to perform one or more operations related to provisioning of multiple platform services. In an example, the platform service provider 114 may provide multiple platform services in the financial domain, including, but not limited to, pricing determination, eligibility check, user authorization, income verification, loan application, document generation, loan compliance, reporting, and security. In some embodiments, the platform service provider 114 may include multiple subsystems to facilitate various platform services.

The external service provider 116 may correspond to a system for providing multiple external or third-party services that are externally integrated with the orchestrator server 110. The external service provider 116 may include suitable logic, circuitry, interfaces, and/or code, executable by the circuitry, that may be configured to perform one or more operations related to provisioning of multiple external services. In an example, the external service provider 116 may provide multiple third-party services in the financial domain, including, but not limited to, automated validation, credit check, title check, notary scheduling, fraud check, document generation, loan closing, loan servicing, and employment verification. In some embodiments, the external service provider 116 may include multiple subsystems to facilitate various platform services.

The manual review provider 118 may correspond to a system for providing additional verification services that are integrated with the orchestrator server 110. The manual review provider 118 may be implemented on a computing device (not shown) which is manually operated by a person to manually perform additional verification required for the first application process. In one embodiment, the additional verification may include verification of documents and/or the first user information provided by the user 106 via the user device 108. Upon completion of the verification process, the orchestrator server 110 may receive, from the manual review provider 118, a result of the verification process indicating one of verification successful or verification failed. Examples of the computing device may include, but are not limited to, a personal computer, a laptop, a smartphone, a smart wearable device, and a tablet computer.

The AI engine 120 may correspond to a system for providing additional verification services that are integrated with the orchestrator server 110. The AI engine 120 may include suitable logic, circuitry, interfaces, and/or code, executable by the circuitry, that may be configured to perform one or more operations related to additional verification required for the first application process. In one embodiment, the additional verification may include verification of documents and/or the first user information provided by the user 106 via the user device 108. Upon completion of the verification process, the orchestrator server 110 may receive, from the manual review provider 118, a result of the verification process indicating one of verification successful or verification failed. In one embodiment, the AI engine 120 may implement an AI model, such as, but not limited to, machine learning models, natural language processing models, deep learning models, and data processing models.

It will be apparent to a person skilled in the art that although in the present embodiment, the manual review provider 118 and the AI engine 120 may provide additional verification services, the scope of the present disclosure is not limited to it. In alternate embodiments, the manual review provider 118 and the AI engine 120 may provide any suitable services related to the first application process which require manual intervention or AI assistance, without deviating from the scope of the present disclosure.

The communication network 122 may include suitable logic, circuitry, interfaces, and/or code, executable by the circuitry, that may be configured to transmit queries, messages, and requests between various entities, such as the configurator device 104, the user device 108, the orchestrator server 110, the database server 112, the platform service provider 114, the external service provider 116, the manual review provider 118, and/or the artificial intelligence (AI) engine 120. Examples of the communication network 122 include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and a combination thereof. Various entities in the environment 100 may connect to the communication network 122 in accordance with various wired and wireless communication protocols, such as HTTP, Transmission Control Protocol and Internet Protocol (TCP/IP), User Datagram Protocol (UDP), Long Term Evolution (LTE) communication protocols, or any combination thereof.

FIG. 2 is a process flow diagram 200 that illustrates configuration and execution of an application process, in accordance with an embodiment of the present disclosure. The process flow diagram 200 may include the configurator device 104, the user device 108, the orchestrator server 110, the database server 112, and the plurality of modular applications 202 including the platform service provider 114, the external service provider 116, the manual review provider 118, and the AI engine 120.

In operation, the configurator device 104 may be utilized, by the configurator 102, to build the application process by providing the set of inputs to generate the configuration file. The configuration file may be associated with the list of services required for the application process. Further, upon provisioning of the set of inputs, the configurator device 104 may be configured to transmit the set of inputs to the orchestrator server 110 via the communication network 122. It will be apparent to a person skilled in the art that the configurator 102 may provide the set of inputs for generation of the plurality of configuration files for the plurality of application processes, without deviating from the scope of the present disclosure.

At 204, the orchestrator server 110 generates the plurality of configuration files based on the set of inputs provided by the configurator 102. Each configuration file comprises a set of states, a set of transitions, and a set of events corresponding to the respective application process of the plurality of application processes. Each configuration file of the plurality of configuration files corresponds to at least one of a file generated utilizing a low code tool, a JavaScript Object Notation (JSON) file, and a customized file. In one example, a custom user journey may be defined using a flow definition language that defines the set of states, the set of transitions, and the set of events for a corresponding application process. Based on the plurality of configuration files generated, the orchestrator server 110 may be configured to configure integration between the plurality of application processes and the plurality of modular applications 202. Each application process of the plurality of application processes is associated with one or more modular applications of the plurality of modular applications 202. In one embodiment, the orchestrator server 110 may determine a set of modular applications from the plurality of modular applications 202 to be integrated for each application process based on the list of services required for each application process. In some embodiments, the orchestrator server 110 may be further configured to store the plurality of configuration files in the database server 112.

At 206, the orchestrator server 110 receives, from the user device 108, a request to initiate the first application process (new application process or existing application process) of the plurality of application processes. The user 106 may utilize the user device 108 to select the first application process from the plurality of application processes to avail the corresponding services. In one example, the user 106 wants to avail a HELOC loan and selects a HELOC loan application process to initiate the first application process.

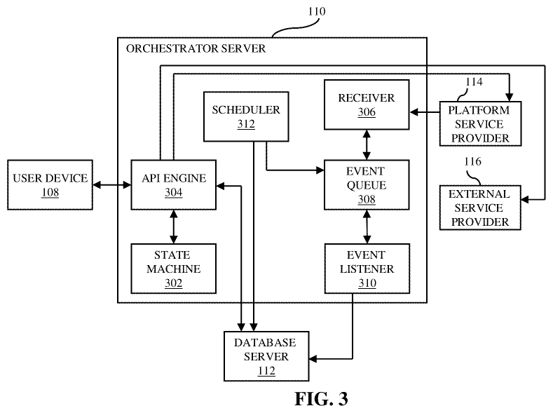

At 208, the orchestrator server 110 retrieves the first configuration file of the plurality of configuration files associated with the first application process and the first state information indicating a current status of the first application process from the database server 112 to initiate the first application process. The first configuration file includes a first set of states, a first set of transitions, and a first set of events. Each state of the first set of states corresponds to a status of the first application process. Each transition of the set of transitions corresponds to a change in the status of the first application process from one state of the first set of states to another state of the first set of states. Each event of the first set of events corresponds to an action that triggers the transition of the first application process from one state of the first set of states to another state of the first set of states. Further, the orchestrator server 110 loads the first set of states, the first set of transitions, and the first set of events in a state machine (shown later in FIG. 3) to monitor and control the flow of the first application process.

Upon initiating the first application process, at 210, the orchestrator server 110 may render a user interface on the user device 108 to receive the first user information for the first application process. The user 106 may utilize the user device 108 to provide the corresponding input by interacting with the user interface. At 212, the orchestrator server 110 receives, from the user device 108, the first user information for the first application process. In one embodiment, the first user information may include at least one of the name, the identification details of the user 106, and application-specific details. In one example, when the user 106 wants to avail an auto loan, the user 106 may provide vehicle details and financial details along with the name and the identification details.

At 214, based on the first state information, the first user information, a response of a current step of the first application process, the first set of states, the first set of transitions, and the first set of events, the orchestrator server 110 determines a next step of the first application process. The next step of the first application process may correspond to an action to be performed by the orchestrator server 110. In one embodiment, the orchestrator server 110 includes the state machine that analyzes the first state information of the first application process and determines whether any event of the set of events has triggered transition of the first application process from one state to another state. For example, if the current state is “receive user information” and the first user information reception from the user device 108 is completed, the state machine transitions the state to the next state in process and accordingly the first state information changes. The orchestrator server 110 thus determines the next step of the application process based on the current first state information. In one embodiment, the next step may correspond to a request to avail a service provided by at least one modular application of the plurality of modular applications 202. Upon the determination of the next step, at 216, the orchestrator server 110 stores the first state information in the database server 112.

At 218, the orchestrator server 110 executes, based on the determined next step, a request to at least one modular application integrated with the first application process. In one embodiment, when the modular application corresponds to an internal platform service application, the orchestrator server 110 transmits, to the platform service provider 114, an application programming interface (API) call to process the request. Based on the API call, the orchestrator server 110 receives, from the platform service provider 114, a response associated with the processing of the request. The response comprises a set of event notifications. In one embodiment, the next step is determined based on the set of event notifications of the response of the current step of the first application process that may be executed by the orchestrator server 110. The set of event notifications may correspond to a status of the event associated with the request to the platform service provider 114. When an event notification of the set of event notifications corresponds to a completion status of the event, the transition of the first application process to the next state may be triggered, thereby progressing the first application process to the next step. Further, in one embodiment, an event notification of the set of event notifications may indicate additional information to be received from the user 106. The orchestrator server 110 may be configured to render a user interface on the user device 108 to receive the additional information. Additionally, in one example, the set of event notifications may be asynchronous event notifications.

In some embodiments, when the modular application corresponds to an external service application, the orchestrator server 110 transmits, to the external service provider 116, an application programming interface (API) call to process the request. Based on the API call, the orchestrator server 110 receives, from the external service provider 116, a response associated with the processing of the request. The response comprises a set of event notifications. In one embodiment, the next step is determined based on the set of event notifications of the response. The set of event notifications may correspond to a status of the event associated with the request to the external service provider 116. When an event notification of the set of event notifications corresponds to a completion status of the event, the transition of the first application process to the next state may be triggered, thereby progressing the first application process to the next step. Further, in one embodiment, an event notification of the set of event notifications may indicate additional information to be received from the user 106. Thus, the orchestrator server 110 may be configured to render a user interface on the user device 108 to receive the additional information. Additionally, in one example, the set of event notifications may be asynchronous event notifications.

In some additional embodiments, when the modular application corresponds to a verification application, the orchestrator server 110 transmits, to one of the manual review provider 118 or the AI engine 120, an application programming interface (API) call to process the request. Based on the API call, the orchestrator server 110 receives, from one of the manual review provider 118 or the AI engine 120, a response associated with the processing of the request. The response comprises a set of event notifications. In one embodiment, the next step is determined based on the set of event notifications of the response. The set of event notifications may correspond to a status of the event associated with the request to one of the manual review provider 118 and the AI engine 120. When an event notification of the set of event notifications corresponds to a completion status of the event, the transition of the first application process to the next state may be triggered, thereby progressing the first application to the next step. Further, in one embodiment, an event notification of the set of event notifications may indicate additional information to be received from the user 106. Thus, the orchestrator server 110 may be configured to render a user interface on the user device 108 to receive the additional information. Additionally, in one example, the set of event notifications may be asynchronous event notifications.

In numerous embodiments, the orchestrator server 110 may transmit multiple API calls to the manual review provider 118 and the AI engine 120 which may be received by a verification queue and processed by the manual review provider 118 and the AI engine 120 based on a first in first out order. It will be understood by a person skilled in the art that the orchestrator server 110 may execute any number of requests to one or more of the plurality of modular applications 202 integrated with the first application process for each step of the first application process, without deviating from the scope of the present disclosure.

Thus, at 218, the orchestrator server 110 transmits the API call to a corresponding modular application of the plurality of modular applications 202. Further, at 220, the orchestrator server 110 receives the response including the set of event notifications from the corresponding modular application. At 222, the orchestrator server 110 renders a user interface on the user device 108 to present the next step based on the first state information, the first user information, the first set of states, the first set of transitions, and the first set of events. In some embodiments, the user interface may be rendered by the orchestrator server 110 to receive the additional information associated with the next step. When the set of event notifications corresponds to a completion status of the event, the transition of the first application process to the next state may be triggered, thereby progressing the first application to the next step. The orchestrator server 110 repeats the determination of the next step, the execution of the at least one request, and the rendering of the user interface, i.e., process steps 214-222, until the first state information indicates completion of the first application process. In an embodiment, at 224, the orchestrator server 110 may provide, to the user device 108, allocation information based on allocation of respective service, such as the auto loan, to the user 106 upon completion of the first application process. The user device 108 may be further utilized, by the user 106, to view the allocation information. In one example, the allocation information may correspond to one of approval or rejection of the auto loan application requested by the user 106 and may include corresponding details.

After completion of the first application process, the orchestrator server 110 may receive, from the user device 108, another request to initiate a second application process of the plurality of application processes. Upon receiving the request to initiate the second application process, the orchestrator server 110 may be configured to retrieve a second configuration file of the plurality of configuration files associated with the second application process and second state information indicating a current status of the second application process from the database server 112 to initiate the second application process. The second configuration file includes a second set of states, a second set of transitions, and a second set of events. Further, the orchestrator server 110 may be configured to receive second user information for the second application process from the user device 108. Based on the second state information, the second user information, the second set of states, the second set of transitions, and the second set of events, the orchestrator server 110 may be configured to determine a next step of the second application process. In one embodiment, based on the determined next step, the orchestrator server 110 may be configured to execute a request to at least one modular application of the plurality of modular applications 202 integrated with the second application process. Furthermore, the orchestrator server 110 may be configured to repeat the determining of the next step and the executing of the request to at least one modular application until the second state information indicates completion of the second application process.

In some embodiments, the orchestrator server 110 may integrate the first application process with at least one of a first modular application and a second modular application, of the plurality of modular applications 202. Further, the orchestrator server 110 may integrate the second application process with at least one of the second modular application and a third modular application of the plurality of modular applications. Thereby, the orchestrator server 110 may reuse the second modular application for the second application process. Additionally, the orchestrator server 110 may reuse any of the modular applications for any number of application processes. In one embodiment, the orchestrator server 110 may execute each application process one at a time, i.e., execute the second application process after the completion of the first application process. In another embodiment, the orchestrator server 110 may execute multiple application processes parallelly or simultaneously, i.e., execute the first and second application processes simultaneously without waiting for the completion of the first application process.

It will be apparent to a person skilled in the art that although in the present embodiment, the user 106 utilizes the user device 108 to provide the requests to initiate the first and second application processes, the scope of the present disclosure is not limited to it. In an alternate embodiment, two different users may utilize their respective user devices to provide the requests to initiate the first and second application processes, respectively, without deviating from the scope of the present disclosure.

In this manner, the orchestrator server 110 may be invoked in any request made from a user interface (web application, mobile application, or a chat bot) rendered on the user device 108. On invocation of the request, the orchestrator server 110 looks up the state machine and fetches the states, transitions, and events for the respective application process. Based on the fetched data, the orchestrator server 110 determines the next steps based on transitions and conditions and fetches all the actions that the orchestrator server 110 needs to perform to process the given request. In one embodiment, the orchestrator server 110 may orchestrate all the backend interactions defined by the actions (API service calls, function calls, AI engine interaction, or human manual interaction) to be executed by the plurality of modular applications 202.

The orchestrator server 110 may thus facilitate a dynamically configurable and autonomously manageable software product solution having flexibility to design, develop, and deploy solutions rapidly across all aspects of the product development cycle. A front end module, i.e., the user device 108 on which the service application is running, provides a platform where the experience is built dynamically based on configuration of the overall user experience, with specific components included or excluded depending on the needs for a specific experience. For example, the same platform may be used to build a university application journey, a home equity lending journey, and/or other processes with equal ease. The ordering, addition/deletion, or modification of the user journey may be configurable by generation of respective configuration files.

The backend module, i.e., the plurality of modular applications 202, may support abstraction of external third-party integrations while allowing for flexible and dynamic selection of the right services for the right customer/product scenario in a pluggable fashion. For example, in a financial use case, the integrations may include a credit check service, an identification (ID) verification service, an income verification service, and the like. In an auto insurance use case, the integrations may include a vehicle title check service, external quote management service, and the like. For a university application use case, the integrations may include a references authentication service, a plagiarism check service, and the like.

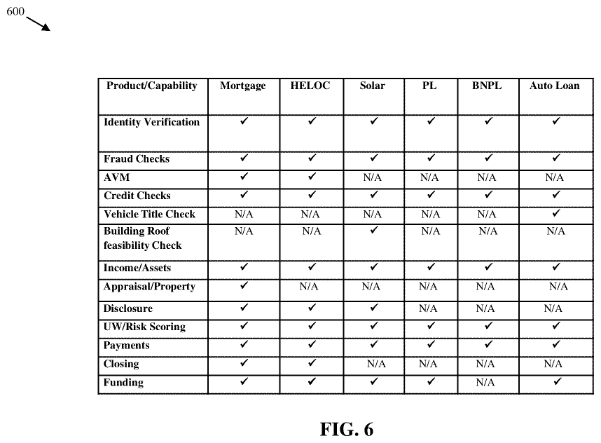

The plurality of modular applications 202 provide the ability to compose together orchestrated flows that may be integrated and customized to rapidly build and deploy custom user journeys for various products. In other words, the plurality of modular applications 202 may orchestrate digital, manual intervention, AI system, and a functional service to build custom user journeys. The API call utilized to fulfill the request to the plurality of modular applications 202 may allow for efficient customization and programmability for financial applications, or any other applications. Thus, it results in a common platform to build user journeys, experiences, and backend system integrations for a variety of products as shown later in FIG. 6. Various other functionalities and operations of the orchestrator server 110 have been described in detail in conjunction with FIGS. 3-8.

FIG. 3 is a block diagram that illustrates the orchestrator server 110, in accordance with an embodiment of the disclosure. The orchestrator server 110 may include a state machine 302, an API engine 304, a receiver 306, an event queue 308, an event listener 310, and a scheduler 312.

The state machine 302 may include suitable logic, circuitry, interfaces, and/or code, executable by the circuitry, that may be configured to perform one or more operations related to monitoring and processing the flow of the plurality of application processes. In some embodiments, the state machine 302 may be configured to receive the first set of states, the first set of transitions, the first set of events, and the first state information from the database server 112 when the first application process is initiated. Based on the first state information, the state machine 302 may be configured to monitor the first set of states, the first set of transitions, and the first set of events corresponding to the first application process. The state machine 302 may be configured to initiate in an initial state, detect the conditions or events triggering transitions, transition to different states according to the detected conditions (transitions) triggered by specific events or inputs, and update the first state information.

The API engine 304 may include suitable logic, circuitry, interfaces, and/or code, executable by the circuitry, that may be configured to perform one or more operations related to requests to the plurality of modular applications 202 for availing various services required by the plurality of application processes. The API engine 304 may be coupled to the state machine 302 and configured to receive a plurality of requests for transmitting a plurality of API calls to at least one of the platform service provider 114, the external service provider 116, the manual review provider 118, and the AI engine 120 based on the first state information and the next step of the first application process. Based on the plurality of requests, the API engine 304 may be configured to generate the plurality of API calls and transmit each of the plurality of API calls to the respective modular application, such as the platform service provider 114, the external service provider 116, the manual review provider 118, or the AI engine 120.

The receiver 306, the event queue 308, and the event listener 310 may include suitable logic, circuitry, interfaces, and/or code, executable by the circuitry, that may be configured to perform one or more operations related to execution of requests associated with the plurality of application processes. The receiver 306 may be configured to receive a plurality of responses associated with the plurality of API calls from at least one of the platform service provider 114, the external service provider 116, the manual review provider 118, or the AI engine 120. Each response of the plurality of responses comprises a set of event notifications. In one embodiment, the receiver 306 may correspond to a webhook receiver which is a server-side endpoint that listens for incoming HTTP POST requests from external services, such as the plurality of modular applications 202, known as webhooks. When an event occurs in one of the plurality of modular applications 202, one of the platform service provider 114, the external service provider 116, the manual review provider 118, and the AI engine 120 may send a notification to the receiver 306, which processes the data and triggers specific actions based on the event.

The event queue 308 may be configured to store the first set of events based on the first state information and the set of event notifications. In one embodiment, the event queue 308 may correspond to a data structure used in event-driven programming to hold and manage events as they occur. When an event is triggered, such as a user action (clicking a button, typing on the keyboard) or a system event (timer expiration, information reception), the event is added to the event queue. The event queue 308 may be configured to organize these events of the first set of events in the order they occur, ensuring they are processed sequentially. This mechanism allows for efficient handling of multiple events, preventing the system from becoming overwhelmed by simultaneous actions. When the receiver 306 receives a response of the plurality of responses along with an event notification of the set of event notifications corresponding to a specific event, the receiver 306 triggers the specific action based on the event and sequence of the event in the event queue 308.

The event listener 310 may be configured to monitor each event of the first set of events in the event queue 308 when the specific event is triggered, transition the first application process from one state to another state based on the first state information and the set of event notifications, and store the first state information in the database server 112. In one embodiment, the event listener 310 corresponds to a function or method that waits for and responds to specific events. The event listener 310 is associated with a particular type of event (e.g., click, keypress) and a target element (e.g., a button, an input field) for each event. When the specified event occurs, the event listener 310 is triggered, and the corresponding function or method is executed, thereby transitioning the state of the first application process.

The scheduler 312 may include suitable logic, circuitry, interfaces, and/or code, executable by the circuitry, that may be configured to perform one or more operations related to the plurality of application processes. The scheduler 312 may be configured to periodically execute a set of scheduled tasks associated with the first application process. In one example, the scheduler 312 may be configured to detect and discard stale requests by the user 106 for availing specific application processes. The stale requests may correspond to requests generated by the user 106 for availing specific application processes and are pending for completion of the first application process due to the user 106 not accessing the first application process for a predefined period of time. In one example, the predefined period of time to mark any request made by the user 106 as a stale request is 7 days. However, in other embodiments, the predefined period of time may have other values.

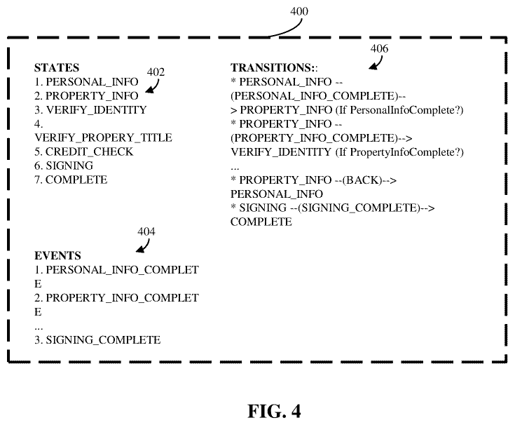

FIG. 4 is a diagram that illustrates a configuration file 400 associated with an application process, in accordance with an embodiment of the disclosure. In one embodiment, the configuration file 400 corresponds to a custom user journey defined using a flow definition language that defines a set of states 402, a set of events 404, and a set of transitions 406 for a corresponding application process. The flow definition language may be authored using at least one of a JSON file, a domain-specific artifact language, and a low code WYSIWYG tool. Referring to FIG. 4, the configuration file 400 is a custom user journey defined for a HELOC application.

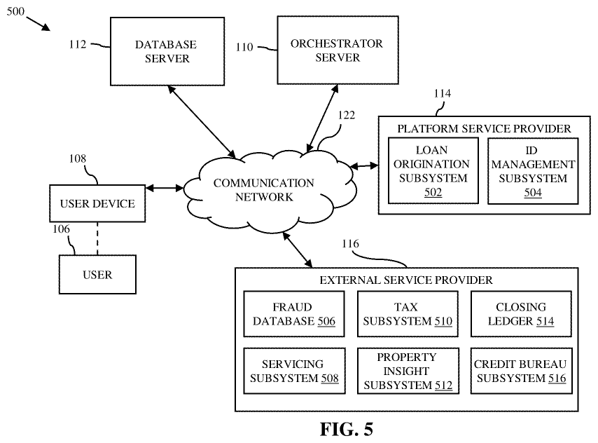

FIG. 5 is a block diagram that illustrates a customized environment 500 for a HELOC application process, in accordance with an embodiment of the disclosure. In one embodiment, the customized environment 500 may include the user 106, the user device 108, the orchestrator server 110, the database server 112, the platform service provider 114, and the external service provider 116. The platform service provider 114 may include multiple subsystems, such as, a loan origination subsystem 502 and an ID management subsystem 504 to provide various internal platform services required by the HELOC application process. In one embodiment, the list of internal platform services provided by the platform service provider 114 includes, but is not limited to, pricing service, user authorization, user entity service, income verification, loan compliance, reporting service, eligibility service, loan origination proxy service, document generation, and security. The external service provider 116 may include multiple subsystems, such as, a fraud database 506, a servicing subsystem 508, a tax subsystem 510, a property insight system 512, a closing ledger 514, and a credit bureau subsystem 516 to provide various third-party services required by the HELOC application process. In one embodiment, the list of third-party services provided by the external service provider 116 includes, but is not limited to, automated valuation modeling, title check, notary scheduling, fraud detection, loan servicing, credit check, loan origination proxy, document generation, loan closing, and employment verification. Further, the orchestrator server 110 may include a loan processing queue (not shown) to hold and manage HELOC applications in an order as they are received.

Referring now to FIGS. 4 and 5, in one embodiment, the orchestrator server 110 receives, from the user device 108, a request to initiate a HELOC application process. The user 106 may utilize the user device 108 to select the HELOC application process from the plurality of application processes to avail the HELOC services. The orchestrator server 110 retrieves the configuration file 400 and state information indicating a current status of the HELOC application process from the database server 112 to initiate the HELOC application process. The configuration file 400 includes the set of states 402, the set of transitions 406, and the set of events 404. Each state of the set of states 402 corresponds to a distinct status of the HELOC application process, for example, “PERSONAL_INFO” state indicates the process of obtaining the user information from the user 106. Each event of the first set of events 404 corresponds to an action that triggers transition of the HELOC application process from one state of the first set of states to another state of the first set of states, for example, “PERSONAL_INFO_COMPLETE” event transitions the HELOC application process from “PERSONAL_INFO” state to “PROPERTY_INFO” state. Each transition of the set of transitions 406 corresponds to a change in a status of the HELOC application process from one state of the first set of states to another state of the first set of states based on a condition, for example, transition from “PERSONAL_INFO” state to “PROPERTY_INFO” state based on “PERSONAL_INFO_COMPLETE” event. Further, the orchestrator server 110 loads the first set of states 402, the first set of transitions 406, and the first set of events 404 in the state machine 302 to monitor and control the flow of the HELOC application process.

Upon initiating the HELOC application process, the state information may correspond to “PERSONAL_INFO” state and the orchestrator server 110 may render a user interface on the user device 108 to receive the user information for the HELOC application process. The user 106 may utilize the user device 108 to provide the corresponding input by interacting with the user interface. The orchestrator server 110 may receive, from the user device 108, the user information for the HELOC application process. Upon receiving the user information, the orchestrator server 110 detects that the “PERSONAL_INFO_COMPLETE” event is triggered and the state machine 302 transitions the state of the HELOC application from “PERSONAL_INFO” state to “PROPERTY_INFO” state and the state information is updated accordingly. The orchestrator server 110 stores the updated state information in the database server 112. Based on the state information, the user information, a response of a current step, i.e., step of obtaining personal information, the set of states, the set of transitions, and the set of events, the orchestrator server 110 determines a next step of the HELOC application process, i.e., obtaining property information. The next step of the first application process may correspond to an action to be performed by the orchestrator server 110. In one embodiment, the next step may correspond to a request to avail a service provided by at least one modular application of the plurality of modular applications, such as the platform service provider 114 and the external service provider 116. Upon determination of the next step, the orchestrator server 110 stores the state information in the database server 112.

The orchestrator server 110 may execute, based on the determined next step, at least one request to at least one of the platform service provider 114 and the external service provider 116 integrated with the HELOC application process. For example, when the action in the next step corresponds to availing pricing service, the orchestrator server 110 may transmit, to the platform service provider 114, an application programming interface (API) call to process the pricing service request. Based on the API call, the orchestrator server 110 may receive, from the platform service provider 114, a response (e.g., pricing calculation of the property) associated with the processing of the pricing service request. In some embodiments, when the action in the next step corresponds to automated valuation modeling service, the orchestrator server 110 may transmit, to the external service provider 116, an application programming interface (API) call to process the automated valuation modeling request. Based on the API call, the orchestrator server 110 receives, from the external service provider 116, a response (e.g., valuation of the property) associated with the processing of the automated valuation modeling request.

The orchestrator server 110 renders a user interface on the user device 108 to present the processing of the next step to the user 106. When the set of event notifications corresponds to a completion status of the “PROPERTY_INFO” event, the transition of the HELOC application process to the next state may be triggered, thereby progressing the application to the next step. The orchestrator server 110 repeats the determination of the next step, the execution of the at least one request, and the rendering of the user interface, until the state information indicates completion of the HELOC application process.

FIG. 6 is a table 600 illustrating integration of services along with various application processes to be executed by the orchestrator server 110, in accordance with an embodiment of the disclosure. More specifically, a first row in the table 600 indicates various application processes in the financial domain, such as, Mortgage, HELOC, Solar loan, PL, BNPL, and Auto Loan. The list of services required to be integrated with the orchestrator server 110 to execute the application process is then indicated in a first row. Accordingly, in an embodiment, if a particular service is required for an application process, then the corresponding block in the column of the respective application process is marked with a tick. Further, if a particular service is not applicable for an application process, then the corresponding block in the column of the respective application process is marked with a “N/A.” For example, for the Mortgage application process the list of services required are identity verification, fraud check, automated valuation modeling (AVM), credit check, income/asset declaration, appraisal/property service, disclosure, risk scoring, payment service, closing service, and funding service. Similarly, the table 600 indicates the list of services required for the respective application processes. The table 600 illustrates that one service of the list of services may be utilized by more than one process, thereby facilitating reusability and reducing overhead.

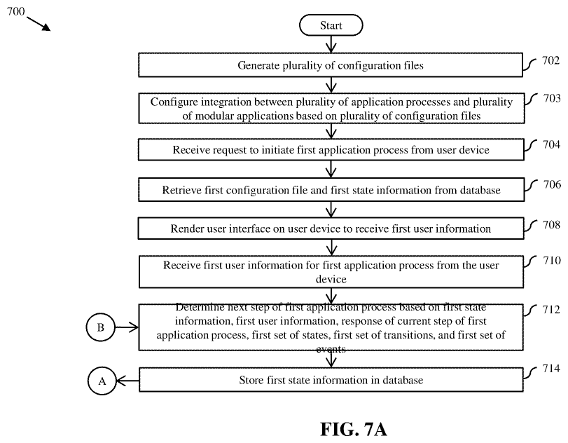

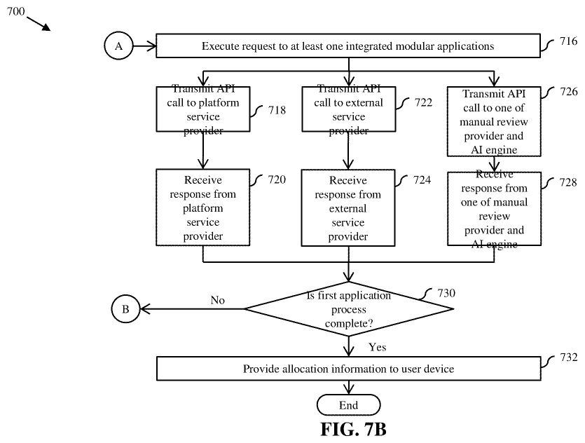

FIGS. 7A and 7B, collectively, represent a flowchart illustrating a method 700 for dynamic configuration and autonomous managing of software product solutions, in accordance with an embodiment of the disclosure.

At 702, the orchestrator server 110 generates the plurality of configuration files associated with the plurality of application processes along with the list of services required for each application process based on the set of inputs received from the configurator device 104. Each configuration file comprises a set of states, a set of transitions, and a set of events corresponding to the respective application process of the plurality of application processes. In one example, a custom user journey may be defined using a flow definition language in corresponding configuration file that defines the set of states, the set of transitions, and the set of events for a corresponding application process. Based on the plurality of configuration files generated, at 703, the orchestrator server 110 may be configured to configure integration between the plurality of application processes and the plurality of modular applications. Each application process of the plurality of application processes is associated with one or more modular applications of the plurality of modular applications.

At 704, the orchestrator server 110 receives a request to initiate the first application process (new application process or existing application process) of the plurality of application processes from the user device 108. The user 106 may utilize the user device 108 to select at least one application process from the plurality of application processes to avail the corresponding services. At 706, the orchestrator server 110 retrieves the first configuration file of the plurality of configuration files associated with the first application process and the first state information indicating a current status of the application process from the database server 112 to initiate the first application process. The first configuration file includes the first set of states, the first set of transitions, and the first set of events. Further, the orchestrator server 110 loads the first set of states, the first set of transitions, and the first set of events in the state machine 302 to monitor and control the flow of the first application process.

At 708, upon initiating the first application process, the orchestrator server 110 may render a user interface on the user device 108 to receive the first user information for the first application process. The user 106 may utilize the user device 108 to provide the corresponding input by interacting with the user interface. At 710, the orchestrator server 110 receives the first user information for the first application process from the user device 108. At 712, based on the first state information, the first user information, a response of a current step of the first application process, the first set of states, the first set of transitions, and the first set of events, the orchestrator server 110 determines a next step of the first application process. The next step of the first application process may correspond to an action to be performed by the orchestrator server 110. Upon determination of the next step, at 714, the orchestrator server 110 stores the first state information in the database server 112.

At 716, the orchestrator server 110 executes, based on the determined next step, a request to at least one modular application integrated with the first application process. In one embodiment, at 718, when the modular application corresponds to an internal platform service application, the orchestrator server 110 transmits an API call to the platform service provider 114 to process the request. At 720, based on the API call, the orchestrator server 110 receives a response associated with the processing of the request from the platform service provider 114. The response may include a set of event notifications that correspond to a status of the event associated with the request to the platform service provider 114. When the set of event notifications corresponds to a completion status of the event, the transition of the application process to the next state may be triggered, thereby progressing the application to the next step.

In some embodiments, at 720, when the modular application corresponds to an external service application, the orchestrator server 110 transmits an API call to the external service provider 116 to process the request. At 722, based on the API call, the orchestrator server 110 receives a response associated with the processing of the request from the external service provider 116. The response may include a set of event notifications that correspond to a status of the event associated with the request to the external service provider 116. When the set of event notifications corresponds to a completion status of the event, the transition of the application process to the next state may be triggered, thereby progressing the application to the next step.

In some more embodiments, at 724, when the modular application corresponds to a verification application, the orchestrator server 110 transmits an API call to one of the manual review provider 118 and the AI engine 120 to process the request. At 726, based on the API call, the orchestrator server 110 receives a response associated with the processing of the request from one of the manual review provider 118 and the AI engine 120. The response may include a set of event notifications that correspond to a status of the event associated with the request to one of the manual review provider 118 and the AI engine 120. When the set of event notifications corresponds to a completion status of the event, the transition of the application process to the next state may be triggered, thereby progressing the application to the next step. At 728, the orchestrator server 110 renders a user interface on the user device 108 to present the next step based on the state information, the user information, the first set of states, the first set of transitions, and the first set of events.

At 730, the orchestrator server 110 determines whether the first application process is complete. If at 730, the orchestrator server 110 determines that the first application process is not complete, 712-728 are executed again. The orchestrator server 110 repeats determining of the next step, the executing of the request, and the rendering of the user interface, until the first state information indicates completion of the first application process. If at 730, the orchestrator server 110 determines that the application process is complete, 732 is executed. At 732, the orchestrator server 110 may provide allocation information to the user device 108 based on allocation of respective service, such as the auto loan, to the user 106 upon completion of the first application process. The user device 108 may be further utilized, by the user 106, to view the allocation information. In one example, the allocation information may correspond to one of approval or rejection of the auto loan application requested by the user 106 and may include corresponding details.

In one embodiment, after completion of the first application process, the orchestrator server 110 may receive, from the user device 108, another request to initiate the second application process of the plurality of application processes. It will be apparent to a person skilled in the art that the second application process may be initiated and progressed till completion in a similar manner as described for the first application process by repeating the method steps 706-732 for the second application process. In this manner, the orchestrator server 110 may be invoked in any request made from a user interface (web application, mobile application, or a chat bot) rendered on the user device 108. On invocation of the request, the orchestrator server 110 looks up the state machine and fetches the states, transitions, and events for the respective application process. Based on the fetched data, the orchestrator server 110 determines the next steps based on transitions and conditions and fetches all the actions that the orchestrator server 110 needs to perform to process the given request. In one embodiment, the orchestrator server 110 may orchestrate all the backend interactions defined by the actions (API service calls, function calls, AI engine interaction, or human manual interaction) to be executed by the plurality of modular applications 202. The important aspect of the orchestrator server 110 is that the orchestrator server 110 knows which actions must be processed successfully to complete a given step (set of actions) and what the next step or transition is based on the configuration file of the respective application process and the state machine. In one embodiment, actions may be events that are asynchronous from one of the plurality of modular applications 202 that result in completion of a given step.

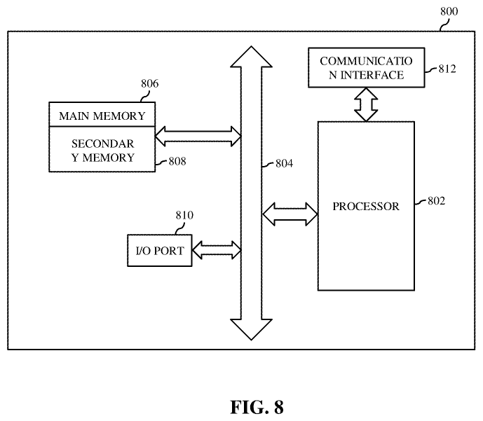

FIG. 8 is a block diagram that illustrates a system architecture of a computer system 800 for dynamic configuration and autonomous managing of software product solutions, in accordance with an exemplary embodiment of the disclosure. An embodiment of the disclosure, or portions thereof, may be implemented as computer-readable code on the computer system 800. In one example, the orchestrator server 110 and the database server 112 of FIG. 1 may be implemented in the computer system 800 using hardware, software, firmware, non-transitory computer-readable media having instructions stored thereon, or a combination thereof and may be implemented in one or more computer systems or other processing systems. Hardware, software, or any combination thereof may embody modules and components used to implement the method of FIGS. 7A and 7B.

The computer system 800 may include a processor 802 that may be a special purpose or a general-purpose processing device. The processor 802 may be a single processor, multiple processors, or combinations thereof. The processor 802 may have one or more processor “cores.” Further, the processor 802 may be connected to a communication infrastructure 804, such as a bus, a bridge, a message queue, multi-core message-passing scheme, the communication network 122, or the like. The computer system 800 may further include a main memory 806 and a secondary memory 808. Examples of the main memory 806 may include RAM, ROM, and the like. The secondary memory 808 may include a hard disk drive or a removable storage drive (not shown), such as a floppy disk drive, a magnetic tape drive, a compact disc, an optical disk drive, a flash memory, or the like. Further, the removable storage drive may read from and/or write to a removable storage device in a manner known in the art. In an embodiment, the removable storage unit may be a non-transitory computer-readable recording media.

The computer system 800 may further include an input/output (I/O) port 810 and a communication interface 812. The I/O port 810 may include various input and output devices that are configured to communicate with the processor 802. Examples of the input devices may include a keyboard, a mouse, a joystick, a touchscreen, a microphone, and the like. Examples of the output devices may include a display screen, a speaker, headphones, and the like. The communication interface 812 may be configured to allow data to be transferred between the computer system 800 and various devices that are communicatively coupled to the computer system 800. Examples of the communication interface 812 may include a modem, a network interface, i.e., an Ethernet card, a communication port, and the like. Data transferred via the communication interface 812 may be signals, such as electronic, electromagnetic, optical, or other signals as will be apparent to a person skilled in the art. The signals may travel via a communications channel, such as the communication network 122, which may be configured to transmit the signals to the various devices that are communicatively coupled to the computer system 800. Examples of the communication channel may include a wired, wireless, and/or optical medium such as cable, fiber optics, a phone line, a cellular phone link, a radio frequency link, and the like. The main memory 806 and the secondary memory 808 may refer to non-transitory computer-readable mediums that may provide data that enables the computer system 800 to implement the methods illustrated in FIGS. 7A and 7B.

The disclosed embodiments encompass numerous advantages. The disclosure provides various methods and systems for dynamically configuring and autonomously managing software product solutions. The disclosed methods and systems may facilitate the orchestrator server 110 that is fully configurable. The orchestrator server 110 supports creating custom user journeys by mapping user journeys to a set of backend actions/states and conditions, integrating actions for each user interaction (function calls, service APIs, manual human integration, AI engine interactions) and stitching all of this to easily plug custom digital applications journeys that are tied by multiple backend interactions. The aforementioned solution thus has significant benefits over traditional software development processes, such as, but not limited to, rapid innovation across new businesses and product types, efficient reuse of technology systems and development resources, maximum reusability of sub-systems and services, high confidence quality checking as well as reusability of test harnesses, ability to react to changes in business needs and requirements, no-code solutions to new products via configurable products, orchestrated custom user journeys based on product and business needs, and efficient combination of automated digital tasks and custom manual tasks all seamlessly plugged into a unified user journey.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however some of the operations may in fact be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the disclosure provide, among other features, systems and methods for dynamic configuring and autonomous managing of software product solutions. While various exemplary embodiments of the disclosed systems and methods have been described above, it should be understood that they have been presented for purposes of example only, and not limitations. It is not exhaustive and does not limit the disclosure to the precise form disclosed. Modifications and variations are possible in light of the above teachings or may be acquired from practicing of the disclosure, without departing from the breadth or scope.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

While various embodiments of the disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

What is claimed is:

1. A method, comprising:
configuring, by a server, integration between a plurality of application processes and a plurality of modular applications based on a plurality of configuration files associated with the plurality of application processes, wherein each application process of the plurality of application processes is associated with one or more modular applications of the plurality of modular applications;
receiving, by the server from a user device, a request to initiate a first application process of the plurality of application processes;
retrieving, by the server from a database, a first configuration file of the plurality of configuration files associated with the first application process and first state information indicating a current status of the first application process to initiate the first application process, wherein the first configuration file includes a first set of states, a first set of transitions, and a first set of events;
receiving, by the server from the user device, first user information for the first application process;
determining, by the server, a next step of the first application process based on the first state information, the first user information, the first set of states, the first set of transitions, and the first set of events;
executing, by the server based on the determined next step, a request to at least one modular application of the plurality of modular applications integrated with the first application process; and
repeating, by the server, the determining of the next step and the executing of the request to the at least one modular application of the plurality of modular applications integrated with the first application process, until the first state information indicates completion of the first application process.

2. The method of claim 1, further comprising:
generating, by the server, the plurality of configuration files, wherein each configuration file comprises a set of states, a set of transitions, and a set of events associated with a corresponding application process of the plurality of application processes, and wherein each configuration file of the plurality of configuration files corresponds to at least one of a file generated utilizing a low code tool, a JavaScript Object Notation (JSON) file, or a customized file.

3. The method of claim 1, wherein
each state of the first set of states corresponds to a status of the first application process,
each transition of the first set of transitions corresponds to a change in the status of the first application process from one state of the first set of states to another state of the first set of states, and
each event of the first set of events corresponds to an action that triggers the transition of the first application process from one state of the first set of states to another state of the first set of states.

4. The method of claim 1, wherein when the at least one modular application corresponds to an internal platform service application, the executing of the request to the at least one modular application comprises:
transmitting, by the server to a platform service provider, an application programming interface (API) call to process the request; and
receiving, by the server from the platform service provider, a response associated with the processing of the request, wherein the response comprises a set of event notifications, and wherein the next step is determined based on the set of event notifications.

5. The method of claim 1, wherein when the at least one modular application corresponds to an external service application, the executing of the request to the at least one modular application comprises:
transmitting, by the server to an external service provider, an API call to process the request; and
receiving, by the server from the external service provider, a response associated with the processing of the request, wherein the response comprises a set of event notifications, and wherein the next step is determined based on the set of event notifications.

6. The method of claim 1, further comprising:
transmitting, by the server to one of a manual review provider or an artificial intelligence (AI) engine, an API call to process the request; and
receiving, by the server from one of the manual review provider and the AI engine, a response associated with the processing of the request, wherein the response comprises a set of event notifications, and wherein the next step is determined based on the set of event notifications.

7. The method of claim 1, further comprising storing, by the server, the first state information in the database.

8. The method of claim 1, further comprising:
rendering, by the server, a user interface on the user device to present the next step based on the first state information, the first user information, the first set of states, the first set of transitions, and the first set of events; and
repeating, by the server, the rendering of the user interface to present the next step until the first state information indicates completion of the first application process.

9. The method of claim 1, further comprising:
receiving, by the server from the user device, a request to initiate a second application process of the plurality of application processes;
retrieving, by the server from the database, a second configuration file of the plurality of configuration files associated with the second application process and second state information indicating a current status of the second application process to initiate the second application process, wherein the second configuration file includes a second set of states, a second set of transitions, and a second set of events;
receiving, by the server from the user device, second user information for the second application process;
determining, by the server, a next step of the second application process based on the second state information, the second user information, the second set of states, the second set of transitions, and the second set of events;
executing, by the server based on the determined next step, a request to at least one modular application of the plurality of modular applications integrated with the second application process; and
repeating, by the server, the determining of the next step and the executing of the request to the at least one modular application of the plurality of modular applications integrated with the second application process, until the second state information indicates completion of the second application process.

10. The method of claim 9, wherein the server integrates (i) the first application process with at least one of a first modular application and a second modular application, of the plurality of modular applications and (ii) the second application process with at least one of the second modular application and a third modular application of the plurality of modular applications.

11. A system, comprising:
a server configured to:
configure integration between a plurality of application processes and a plurality of modular applications based on a plurality of configuration files associated with the plurality of application processes, wherein each application process of the plurality of application processes is associated with one or more modular applications of the plurality of modular applications;
receive, from a user device, a request to initiate a first application process of the plurality of application processes;
retrieve, from a database, a first configuration file of the plurality of configuration files associated with the first application process and first state information indicating a current status of the first application process to initiate the first application process, wherein the first configuration file includes a first set of states, a first set of transitions, and a first set of events;
receive, from the user device, first user information for the first application process;
determine a next step of the first application process based on the first state information, the first user information, the first set of states, the first set of transitions, and the first set of events;
execute, based on the determined next step, a request to at least one modular application of the plurality of modular applications integrated with the first application process; and
repeat the determination of the next step and the execution of the request to the at least one modular application integrated with the first application process, until the first state information indicates completion of the first application process.

12. The system of claim 11, wherein the server is further configured to:
generate the plurality of configuration files, wherein each configuration file comprises a set of states, a set of transitions, and a set of events associated with a corresponding application process of the plurality of application processes, and wherein each configuration file of the plurality of configuration files corresponds to at least one of a file generated utilizing a low code tool, a JavaScript Object Notation (JSON) file, or a customized file.

13. The system of claim 11, wherein
each state of the first set of states corresponds to a status of the first application process,
each transition of the first set of transitions corresponds to a change in the status of the first application process from one state of the first set of states to another state of the first set of states, and
each event of the first set of events corresponds to an action that triggers the transition of the first application process from one state of the first set of states to another state of the first set of states.

14. The system of claim 11, wherein when the at least one modular application corresponds to an internal platform service application, the server is further configured to:
transmit, to a platform service provider, an application programming interface (API) call to process the request; and
receive, from the platform service provider, a response associated with the processing of the request, wherein the response comprises a set of event notifications, and wherein the next step is determined based on the set of event notifications.

15. The system of claim 11, wherein when the at least one modular application corresponds to an external service application, the server is further configured to:
transmit, to an external service provider, an API call to process the request; and
receive, from the external service provider, a response associated with the processing of the request, wherein the response comprises a set of event notifications, and wherein the next step is determined based on the set of event notifications.

16. The system of claim 11, wherein the server is further configured to:
transmit, to one of a manual review provider or an artificial intelligence (AI) engine, an API call to process the request; and
receive, from one of the manual review provider and the AI engine, a response associated with the processing of the request, wherein the response comprises a set of event notifications, and wherein the next step is determined based on the set of event notifications.

17. The system of claim 11, wherein the server is further configured to store the first state information in the database.

18. The system of claim 11, wherein the server is further configured to:
render a user interface on the user device to present the next step based on the first state information, the first user information, the first set of states, the first set of transitions, and the first set of events; and
repeat the rendering of the user interface to present the next step until the first state information indicates completion of the first application process.

19. The system of claim 11, wherein the server is further configured to:
receive, from the user device, a request to initiate a second application process of the plurality of application processes;
retrieve, from the database, a second configuration file of the plurality of configuration files associated with the second application process and second state information indicating a current status of the second application process to initiate the second application process, wherein the second configuration file includes a second set of states, a second set of transitions, and a second set of events;
receive, from the user device, second user information for the second application process;
determine a next step of the second application process based on the second state information, the second user information, the second set of states, the second set of transitions, and the second set of events;
execute, based on the determined next step, a request to at least one modular application of the plurality of modular applications integrated with the second application process; and
repeat the determination of the next step and the execution of the request to the at least one modular application of the plurality of modular applications integrated with the second application process, until the second state information indicates completion of the second application process, wherein the server integrates (i) the first application process with at least one of a first modular application and a second modular application, of the plurality of modular applications and (ii) the second application process with at least one of the second modular application and a third modular application of the plurality of modular applications.

20. The system of claim 11, wherein the server comprises:
a state machine configured to monitor the first set of states, the first set of transitions, and the first set of events corresponding to the first application process;
an API engine coupled to the state machine and configured to receive a plurality of requests for transmitting a plurality of API calls to at least one of a platform service provider, an external service provider, a manual review provider, or an AI engine based on the first state information of the first application process;
a receiver configured to receive a plurality of responses associated with the plurality of API calls, wherein each response of the plurality of responses comprises a set of event notifications;
an event queue configured to store the first set of events based on the first state information and the set of event notifications;
an event listener configured to monitor each event of the first set of events in the event queue, transition the first application process from one state to another state based on the first state information and the set of event notifications, and store the first state information in the database; and
a scheduler configured to periodically execute a set of scheduled tasks associated with the first application process.
